(19) United States
(12) Patent Application Publication
(10) Pub. No.: US 2026/0334726 A1
(43) Pub. Date: Oct. 29, 2026

(54) CHARCOAL IGNITER

(71) Applicant: Aurora International Limited, Hong Kong (HK)

(72) Inventors: Chiko Jeckle Chan, Vancouver (CA); Shuaisi Ye, Shenzhen (CN)

(21) Appl. No.: 19/700,443

(22) Filed: Jun. 8, 2026

Related U.S. Application Data
(63) Continuation of application No. PCT/CN2024/137620, filed on Dec. 6, 2024.

(30) Foreign Application Priority Data
Dec. 8, 2023 (CN) 202323359765.8

(51) Int. Cl. A47J 37/07

(52) U.S. Cl. CPC A47J 37/079

(57) ABSTRACT

A charcoal igniter includes a charcoal combustion cylinder having an open-top cylindrical structure, a lower end of an interior of the charcoal combustion cylinder fixedly installed with a charcoal support tray; and further includes an ignition material combustion tray provided at a bottom of the charcoal combustion cylinder, an interior of the ignition material combustion tray sequentially provided from top to bottom with a fuel layer, an air compression layer, and a power layer. An air passage is provided through a middle portion between the air compression layer and the power layer, and a turbo fan is fixedly installed at one side inside the power layer, an output end of the turbo fan being in communication with a lower end of the air passage.

### CROSS REFERENCE TO RELATED APPLICATIONS

The present application is a Continuation Application of PCT Application No. PCT/CN2024/137620 filed on Dec. 6, 2024, which claims the benefit of Chinese Patent Application No. 202323359765.8 filed on Dec. 8, 2023. All the above are hereby incorporated by reference in their entirety.

### TECHNICAL FIELD

The present application belongs to the technical field of charcoal ignition devices, specifically a charcoal igniter.

### BACKGROUND TECHNOLOGY

To ignite charcoal for grilling, the usual methods are to place various chemical products at the bottom of the charcoal to burn or to place various flammable materials at the bottom of the charcoal to ignite it. For example, many charcoal igniters on the market use solid alcohol or newspaper to ignite the charcoal inside the igniter, or a handheld hot-air lighter is used to ignite the charcoal.

Current charcoal igniters require a relatively long waiting time when flammable materials are placed at the bottom to ignite the charcoal, and generate a large amount of smoke during the ignition process. Alternatively, they may require electric heating for ignition, which not only limits the location of use but also increases the risk of safety issues. Furthermore, using chemical fuels to ignite the charcoal is less safe and environmentally unfriendly, failing to meet the growing needs of users.

### SUMMARY OF THE APPLICATION

To overcome the shortcomings of the prior art, an objective of the present application is to provide a charcoal igniter.

The technical solution adopted in the present application is as follows: a charcoal igniter, including:
a charcoal combustion cylinder, having an open-top cylindrical structure, a lower end of an interior of the charcoal combustion cylinder fixedly installed with a charcoal support tray;
an ignition material combustion tray, provided at a bottom of the charcoal combustion cylinder, an interior of the ignition material combustion tray sequentially provided from top to bottom with a fuel layer, an air compression layer, and a power layer, an air passage provided through a middle portion between the air compression layer and the power layer, a turbo fan fixedly installed at one side inside the power layer, an output end of the turbo fan being in communication with a lower end of the air passage.

Through the above technical solution, the charcoal to be ignited is placed on the upper surface of the charcoal support tray, and the ignition material is placed inside the fuel layer and is ignited. After the ignition material is ignited, the ignition material combustion tray is placed at the bottom of the charcoal combustion cylinder. At this time, the turbo fan is started to generate airflow that enters the air compression layer through the air passage. The air is compressed by the air compression layer and sent into the fuel layer to provide the ignition material for rapid combustion. Furthermore, the high-temperature combustion gas is continuously jetted upwards into the charcoal combustion cylinder to ignite the charcoal.

In a preferred embodiment, an ignition material support plate is integrally provided at an inner bottom of the fuel layer, and a plurality of air jet orifices are formed through the ignition material support plate.

Through the above technical solution, the ignition material is supported by the ignition material support plate, while the compressed air comes into contact with the ignition material through the air jet orifices.

In a preferred embodiment, a metal spacer is welded inside the air compression layer. The metal spacer has a spiral structure and is arranged in a clockwise or counterclockwise direction.

Through the above technical solution, the turbo fan rapidly jets air into the air compression layer. The high-speed air rotates and is compressed along the metal spacer of the air compression layer. At the end of the metal spacer, the air is blocked in its forward direction, swirled back, and jetted through the air jet orifices 210 at the bottom of the fuel layer on the top of the air compression layer. This results in the jetted air being particularly high-speed and rotating clockwise or counterclockwise, thereby making the combustion more complete.

In a preferred embodiment, a heat insulation plate is provided at an inner bottom of the air compression layer.

Through the above technical solution, the setting up of the heat insulation plate protects electronic equipment such as the turbo fan by insulating the heat generated by the combustion at the fuel layer.

In a preferred embodiment, a circuit control power supply is fixedly installed at another side inside the power layer, and the circuit control power supply is electrically connected to the turbo fan.

Through the above technical solution, the circuit control power supply on one hand supplies power to the turbo fan and on the other hand controls its on/off state and speed. This enables control of the air jetting speed freely, thereby controlling the intensity of the flame of the ignition material.

In a preferred embodiment, a handle is fixedly installed on one side of an outer wall of the charcoal combustion cylinder by bolts.

Through the above technical solution, a handle is used to facilitate the movement and carrying of the device.

In a preferred embodiment, an anti-scald plate is fixedly installed at one end of the handle proximate to the outer wall of the charcoal combustion cylinder.

Through the above technical solution, with the setting up of an anti-scald plate, a user's hands can be prevented from directly contacting the outer wall of the charcoal combustion cylinder, effectively preventing users from being burned.

In a preferred embodiment, an outer wall of the ignition material combustion tray is provided with a plurality of air inlets.

Through the above technical solution, external air enters the ignition material combustion tray through the air inlets.

In a preferred embodiment, the ignition material combustion tray is barrel-shaped or tray-shaped according to requirements.

Through the above technical solution, a barrel shape allows for the placement of more ignition material, such as paper and wood chips, while using a tray-shaped ignition material combustion tray allows for the use of solid alcohol fuels.

In summary, due to the adoption of the above technical solutions, the beneficial effects of the present application are:
1. By using a turbo fan to generate airflow that enters the fuel layer in a clockwise or counterclockwise direction to assist combustion, a large amount of incomplete combustion products are not produced. Moreover, since the air enters in a rotating and jetting manner, very little smoke is generated, making it safer and more environmentally friendly.
2. Due to the large amount of air supporting the combustion, the combustible material in the fuel chamber can burn quickly and completely, producing a large amount of high-temperature gas that follows the jetted air and rotates rapidly upward to ignite the charcoal in the charcoal combustion chamber above, thus achieving the purpose of rapid ignition of the charcoal and higher combustion efficiency.

### DESCRIPTION OF THE DRAWINGS

FIG. 1 is a structural schematic diagram of an embodiment of the present application;

FIG. 2 is an exploded view of the structure of an embodiment of the present application;

FIG. 3 is an exploded view of the structure of the ignition material combustion tray of an embodiment of the present application;

FIG. 4 is a cross-sectional view of an embodiment of the present application.

The diagram shows the following markings: 1—Charcoal combustion cylinder; 101—Charcoal support tray; 102—Handle; 103—Anti-scald plate; 2—Ignition material combustion tray; 201—Fuel layer; 202—Air compression layer; 204—Power layer; 206—Turbo fan; 207—Circuit control power supply; 209—Ignition material support plate; 210—Air jet orifice; 211—Metal spacer.

### DETAILED EMBODIMENTS

To make the objective, technical solution, and advantage of the embodiments of the present application clearer, the technical solutions in the embodiments of the present application will be clearly and completely described below in conjunction with the embodiments of the present application. Obviously, the described embodiments are only some embodiments of the present application, not all embodiments. Based on the embodiments in the present application, all other embodiments obtained by those skilled in the art without creative effort are within the scope of protection of the present application.

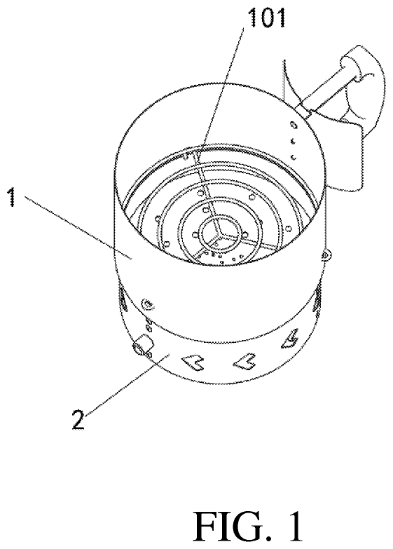

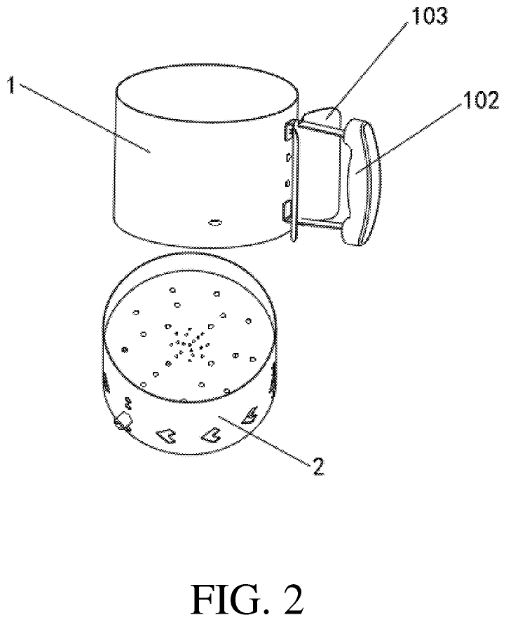

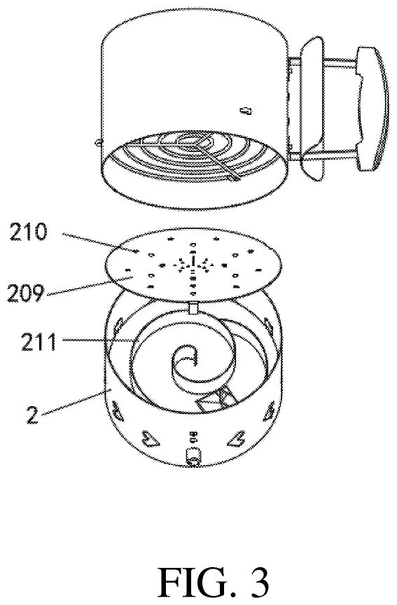

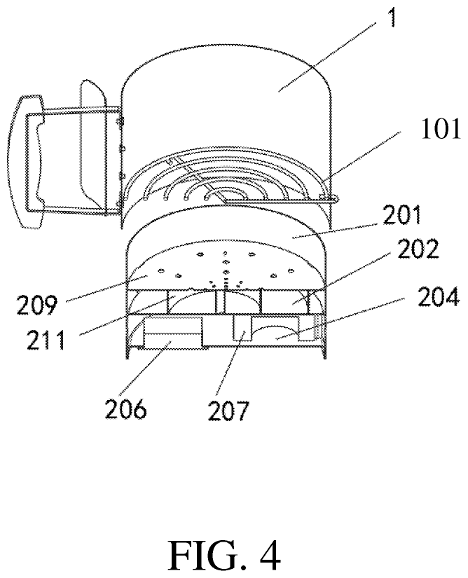

A charcoal igniter according to an embodiment of the present application will be described in detail below with reference to FIGS. 1-4.

A charcoal igniter includes a charcoal combustion cylinder 1, which has an open-top cylindrical structure. A lower end of the interior of the charcoal combustion cylinder 1 is fixedly installed with a charcoal support tray 101. The charcoal to be ignited is placed on the upper surface of the charcoal support tray 101. A handle is fixedly installed on one side of the outer wall of the charcoal combustion cylinder by bolts. The handle 102 is used to facilitate the moving and carrying of the device. An anti-scald plate 103 is fixedly installed at one end of the handle 102 proximate to the outer wall of the charcoal combustion cylinder 1.

The charcoal igniter also includes an ignition material combustion tray 2 provided at the bottom of the charcoal combustion cylinder 1. The outer wall of the ignition material combustion tray 2 is provided with a plurality of air inlets. External air enters the interior of the ignition material combustion tray 2 through the air inlets. The ignition material combustion tray 2 may be barrel-shaped or tray-shaped according to requirements. When it is barrel-shaped, more ignition materials, such as paper or wood chips, can be placed. When using a tray-shaped ignition material combustion tray, solid alcohol fuels or the like can be used. The interior of the ignition material combustion tray 2 is sequentially provided from top to bottom with a fuel layer 201, an air compression layer 202, and a power layer 204. An ignition material support plate 209 is integrally provided at an inner bottom of the fuel layer 201, and a plurality of air jet orifices 210 are formed through the ignition material support plate 209. The ignition material is supported by the ignition material support plate 209, and at the same time compressed air contacts the ignition material through the air jet orifices 210.

A metal spacer 211 is welded inside the air compression layer 202. The metal spacer 211 has a spiral structure and is arranged in a clockwise or counterclockwise direction. The turbo fan rapidly jets air into the air compression layer 202. The high-speed air rotates and is compressed along the metal spacer 211 of the air compression layer 202. When the air reaches the end of the metal spacer 211, the air is blocked in its forward direction, swirled back, and jetted through the air jet orifices 210 at the bottom of the fuel layer on the top of the air compression layer 202. This causes the jetted air to be particularly high-speed and rotate clockwise or counterclockwise, thereby making the combustion more complete.

An air passage is provided through a middle portion between the air compression layer 202 and the power layer 204. A turbo fan 206 is fixedly installed at one side inside the power layer 204. The output end of the turbo fan 206 is in communication with the lower end of the air passage. The heat generated by the combustion of the fuel layer 201 is insulated by a heat insulation plate, thereby protecting the turbo fan and other electronic equipment. A circuit control power supply 207 is fixedly installed at another side inside the power layer 204, and the circuit control power supply 207 is electrically connected to the turbo fan 206. The circuit control power supply on one hand supplies power to the turbo fan and on the other hand controls its on/off state and speed. This enables control of the air jetting speed freely, thereby controlling the intensity of the flame of the ignition material.

The charcoal to be ignited is placed on the upper surface of the charcoal support tray 101, the ignition material is placed inside the fuel layer 201 and is ignited. After the ignition material is ignited, the ignition material combustion tray 2 is placed at the bottom of the charcoal combustion cylinder 1. At this time, the turbo fan 206 is started to generate air that enters the air compression layer 202 through the air passage. The high-speed air is rotated and compressed along the metal spacer 211 of the air compression layer 202. At the end of the metal spacer 211, the air is blocked in its forward direction, swirled back, and jetted through the air jet orifices 210 at the bottom of the fuel layer on the top of the air compression layer 202. This causes the jetted air to be particularly high-speed and rotate clockwise or counterclockwise, thereby making the combustion more complete. This also causes the high-temperature combustion gas to be jetted upward into the charcoal combustion cylinder 1 to ignite the charcoal, so as to achieve the purpose of quickly igniting the charcoal.

The above embodiments are only used to illustrate the technical solutions of the present application, and are not intended to limit them. Although the present application has been described in detail with reference to the foregoing embodiments, those skilled in the art should understand that modifications can still be made to the technical solutions described in the foregoing embodiments, or equivalent substitutions can be made to some of the technical features. Such modifications or substitutions do not cause the essence of the corresponding technical solutions to deviate from the spirit and scope of the technical solutions of the embodiments of the present application.

What is claimed is:

1. A charcoal igniter, characterized in that it comprises:
a charcoal combustion cylinder (1), having an open-top cylindrical structure, a lower end of an interior of the charcoal combustion cylinder (1) fixedly installed with a charcoal support tray (101);
an ignition material combustion tray (2), provided at a bottom of the charcoal combustion cylinder (1), an interior of the ignition material combustion tray (2) sequentially provided from top to bottom with a fuel layer (201), an air compression layer (202), and a power layer (204), an air passage provided through a middle portion between the air compression layer (202) and the power layer (204), a turbo fan (206) fixedly installed at one side inside the power layer (204), an output end of the turbo fan (206) being in communication with a lower end of the air passage.

2. The charcoal igniter as claimed in claim 1, characterized in that: an ignition material support plate (209) is integrally provided at an inner bottom of the fuel layer (201), and a plurality of air jet orifices (210) are formed through the ignition material support plate (209).

3. The charcoal igniter as claimed in claim 1, characterized in that: a metal spacer (211) is welded inside the air compression layer (202), and the metal spacer (211) has a spiral structure and is arranged in a clockwise or counterclockwise direction.

4. The charcoal igniter as claimed in claim 1, characterized in that: a heat insulation plate is provided at an inner bottom of the air compression layer (202).

5. The charcoal igniter as claimed in claim 1, characterized in that: a circuit control power supply (207) is fixedly installed at another side inside the power layer (204), and the circuit control power supply (207) is electrically connected to the turbo fan (206).

6. The charcoal igniter as claimed in claim 1, characterized in that: a handle (102) is fixedly installed on one side of an outer wall of the charcoal combustion cylinder (1) by bolts.

7. The charcoal igniter as claimed in claim 6, characterized in that: an anti-scald plate (103) is fixedly installed at one end of the handle (102) proximate to the outer wall of the charcoal combustion cylinder (1).

8. The charcoal igniter as claimed in claim 1, characterized in that: an outer wall of the ignition material combustion tray (2) is provided with a plurality of air inlets.

9. The charcoal igniter as claimed in claim 1, characterized in that: the ignition material combustion tray (2) is barrel-shaped or tray-shaped according to requirements.
